(19) United States
(12) Patent Application Publication
(10) Pub. No.: US 2002/0008094 A1
(43) Pub. Date: Jan. 24, 2002

(54) Laser/arc hybrid welding process with appropriate gas mixture

(75) Inventors: Francis Briand, Paris (FR); Christian Bonnet, Puiseux-Pontoise (FR); Philippe Lefebvre, Saint Ouen L ' Aumone (FR)

Correspondence Address: YOUNG & THOMPSON, 745 SOUTH 23RD STREET 2ND FLOOR, ARLINGTON, VA, 22202

(73) Assignee: L'Air Liquid, Societe Anonyme Pour L'Etude et L'Explooitation des Procedes Georges

(21) Appl. No.: 09/870,014

(22) Filed: May 31, 2001

(30) Foreign Application Priority Data
May 31, 2000 (FR) 0007013

(51) Int. Cl. B23K 9/00

(52) U.S. Cl. 219/137 R; 219/74; 219/121.64; 219/61

(57) ABSTRACT

Process for welding one or more metal workpieces to be joined together by producing at least one welded joint between the edges to be welded of the said metal workpiece or workpieces, the said welded joint being obtained by using at least one laser beam and at least one electric arc, in which process, during welding of the joint, at least one part of the welding zone comprising at least one part of said welded joint is shielded during the operation with at least one shielding atmosphere formed by a gas mixture consisting of argon and/or helium with a content greater than or equal to 70% by volume; and at least one additional compound chosen from H₂, O₂, CO₂ and N₂ with a content of 0 to 30% by volume.

The present invention relates to a hybrid welding process and to a hybrid welding set combining a laser beam and an electric arc, particularly a plasma arc, using particular gas mixtures as assistance gases for the laser beam and/or for the electric arc, and to its application to the welding of pipes or of tailored blanks.

Laser technology has been known and widely used for years to weld various metallic materials, such as workpieces made of alloy steels or non-alloy steels, coated steels, stainless steels, aluminum and aluminum alloys, or to weld pipes made of various metals.

In general, a laser welding set for welding pipe comprises, apart from the means for feeding and holding the pipe, a solid-state or gas laser oscillator producing a coherent monochromatic high-energy beam, an optical path provided with deviating mirrors or else an optical fiber allowing the laser beam to be conveyed to a welding head located opposite the pipe to be welded.

Conventionally, the welding head comprises a lens or one or more focusing mirrors so as to focus the laser beam onto one or more focal points in the thickness of the material to be welded and in the joint plane obtained by bringing together, edge to edge, either the longitudinal edges of the metal sheet to be welded so as to form a tube (i.e. to form an “O”) manufacturing a pipe, or the edges of the workpieces to be joined together when welding several metal workpieces to one another, for example tailored blanks, so as to locally concentrate sufficient power density to melt the material to be welded.

Usually, the welding head comprises a gas feed device for feeding with welding gas, also called assist gas, by means of a gas delivery nozzle placed coaxially with the laser beam. This gas feed device may also be external to the actual laser welding head.

An alternative solution consists in melting the edges to be joined together in the joint plane by means of one or more electric arcs and using gas either as shielding gas or as active gas.

Such welding processes are also commonly used in industry; depending on the case, these are TIG (Tungsten Inert Gas), MIG (Metal Inert Gas), MAG (Metal Active Gas) processes or else plasma-arc or submerged-arc processes.

Such welding processes are described for example in the following documents: EP-A-847831, U.S. Pat. No. 4,673,121, EP-A-136276, JP-A-58148096, JP-A-03198998, JP-A-03198997, EP-A-896853, U.S. Pat. No. 55,192,016, U.S. Pat. No. 4,738,714, EP-A-899052, JP-A-58107294, EP-A-234623, U.S. Pat. No. 1,872,008, U.S. Pat. No. 4,396,920, U.S. Pat. No. 3,13,284, U.S. Pat. No. 4,811,888 and U.S. Pat. No. 3,931,489.

However, laser welding processes or arc welding processes each have drawbacks which are specific to them and which may or may not vary depending on whether pipe, tailored blanks or other metal workpieces are welded.

For example, in the case of the manufacture of a pipe, the manufacturing process comprises, in general, a phase of forming a pre-tube from a rectangular metal strip or sheet, followed by a phase of welding the pre-tube into a welded pipe.

According to a first technique, the welding is carried out axially, that is to say the metal strip is successively formed into a U and then into an 0 by bringing its two parallel longitudinal edges together so as to obtain an unwelded pre-tube, and then a longitudinal or axial welding of the two edges of the pre-tube to be butted is carried out with or without a groove in order to obtain an axially welded pipe, shown schematically in FIG. 5.

According to a second technique, the welding may be in a helix or spiral. In this case, the metal strip is firstly given a twist in a spiral movement so as to bring together or butt the two longitudinal edges of said strip in a joint plane having the form of a spiral or helix so as to form, here too, an unwelded pre-tube, this pre-tube then being subjected to helical welding so as to join the said two edges together in order to obtain a welded pipe.

Of course, in all cases the pre-tube and the welding head are driven so as to perform a movement of relative displacement one with respect to the other, that is to say either the pipe is stationary and the welding head moves, or vice versa.

The welding phase may be carried out in one or more passes and by using one or more welding processes according to the diameter and the thickness of the pre-tube to be welded.

These operations are carried out at high speed and it is important to use welding processes which allow the desired penetration to be obtained without slowing down the forming process, that is to say also a desired minimum speed making it possible to maintain maximum productivity or, in any case, the highest possible productivity.

Industrial pipe manufacturing lines very often use the multicathode welding process which employs, in general, several plasma or TIG electric arcs aligned in the welding joint plane.

Sometimes, laser welding is also used to weld the pipes. In particular, compared with the multicathode process, the use of a laser makes it possible to increase the speed but to the detriment of increased precision, which therefore requires much more precise alignment of the edges to be welded and precise control of the gap between the edges to be welded. This is very expensive from the standpoint of the tooling to be used.

By analogy, in the case of the welding of tailored blanks, like those intended for the automobile industry, it is necessary to join together two sheets or workpieces, generally made of steel, of galvanized steel, or of aluminum, of different thicknesses and/or different grades.

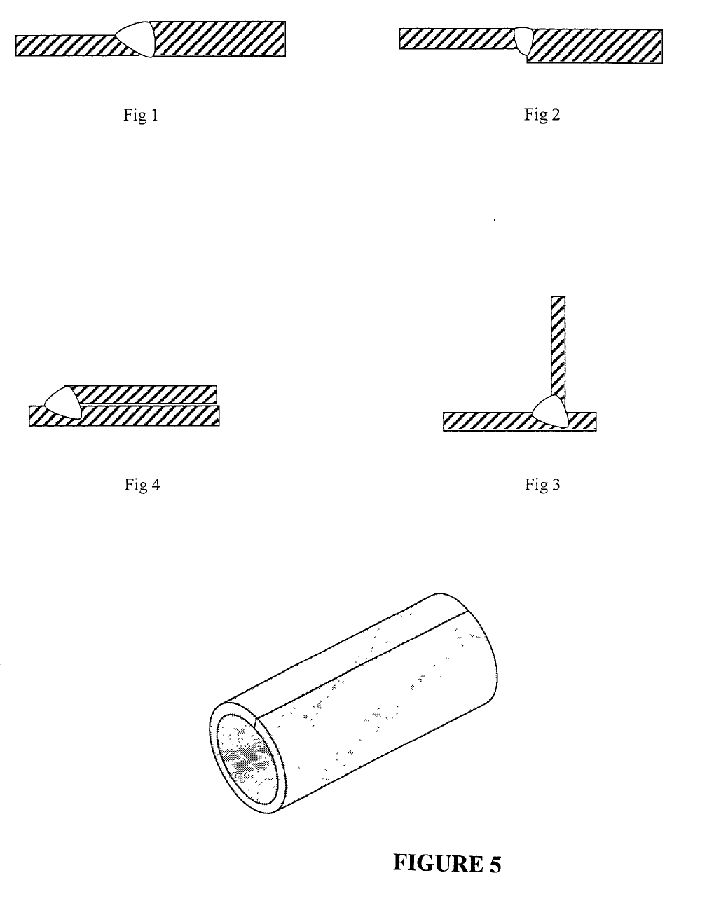

Depending on the welding methods and preparations used, the joint to be welded is often characterized by a difference in level between the upper planes of each of the workpieces to be welded, thus resulting in the creation of a “step”, as shown in FIG. 1. However, it is also possible to encounter the reverse situation, namely joints of the tailored-blank type in which the upper planes are aligned but the lower planes of which are not on the same level and where therefore the “step” is located on the reverse side of the joint to be welded, as may be seen in FIG. 2. Furthermore, the case also exists in which the workpieces to be welded together have the same thickness but are of different grades from each other.

Welds of this kind (FIG. 1 or FIG. 2) are frequently found in the automobile industry in which the workpieces, once they have been welded, are pressed in order to give them their final shapes, for example, the various workpieces which are used in the manufacture of a car body, for example the doors, the roof, the hood or the trunk. They may also be found in the structural elements of the passenger compartment.

In order to improve the known processes for welding pipes or tailored blanks, it has been proposed to weld the edges together by using a hybrid welding process which combines an electric arc with a laser beam, particularly a plasma arc and a laser beam.

Apart from the abovementioned applications, a hybrid welding process is also well suited for welding many other types of joints and may, consequently, be also used for, for example, the angle or corner welds shown schematically in FIG. 3 and the lap weld shown in FIG. 4.

Various arc/laser welding processes have been described, for example in the documents EP-A-793558; EP-A-782489; EP-A-800434; U.S. Pat. No. 5,006,688; U.S. Pat. No. 5,700,989; EP-A-844042; Laser GTA “Welding of aluminium alloy 5052” by T. P. Diebold and C. E. Albright, 1984, pages 18-24; SU-A-1815085 and U.S. Pat. No. 4,689,466; “Plasma arc augmented laser welding” by R. P. Walduck and J. Biffin, pages 172-176, 1994; or “TIG or MIG arc augmented laser welding of thick mild steel plate”, Joining and Materials by J. Matsuda et al., pages 31-34, 1988.

In general, a plasma/laser or more generally an arc/laser, welding process is a hybrid welding process which combines eleczric arc welding with a laser beam.

The arc/laser process consists in generating an electric arc between an electrode, which may or may not be consumable, and the workpiece to be welded, and in focusing a powerful laser beam, especially a YAG-type or CO₂-type laser, in the arc zone, that is to say near or in the joint plane obtained by joining together, edge to edge, the parts of the pre-tube to be welded together.

Such a hybrid process makes it possible to considerably improve the welding speeds compared with laser welding alone or with arc or plasma welding alone and furthermore makes it possible to appreciably increase the tolerances on positioning the edges before welding and the permitted clearance between the edges to be welded, particularly compared with laser welding alone, which requires high precision in positioning the parts to be welded because of the small size of the focal spot of the laser beam.

The use of a plasma/laser process, and more generally an arc/laser process, requires the use of a welding head which makes it possible to combine, in a small space, the laser beam and its focusing device, and a suitable welding electrode.

Several head configurations are described in the abovementioned documents and it may be stated, in summary, that the laser beam and the electric arc or plasma jet may be delivered by one and the same welding head, that is to say they leave via the same orifice, or else via two separate welding heads, one delivering the laser beam and the other the electric arc or plasma jet, the two coming together in the welding zone.

Arc/laser hybrid processes are reputed to be completely suitable for welding tailored blanks for the automobile industry, since they make it possible to obtain a weld bead which is well wetted and free of undercuts, as recalled in the documents EP-A-782 489 and “Laser plus arc equal power”, Industrial Laser Solutions, February 1999, pages 28-30.

In general, when producing the welded joint, it is indispensable to use an assist gas for assisting the laser beam and for shielding the welding zone from external attack and a gas for the electric arc, particularly a plasma gas serving to create the plasma jet of the arc in the case of a plasma arc process.

However, it has been observed in practice that the results, that is to say the quality of the weld obtained, can vary considerably according to the gases used as laser-beam assist gas and as plasma gas.

In addition, because of possible incompatibilities between the gas and the workpieces to be welded by the hybrid process, it is not possible to use just any gas and in just any manner; in particular, it is usually recommended not to weld aluminum with a gas containing CO₂ or O₂ insofar as these compounds cause significant reduction in the mechanical properties of the weld obtained, that is to say they increase the risk of the weld failing.

Similarly, it is known that oxygen and carbon dioxide must not be brought into direct contact with the tungsten electrode used to generate the electric arc, in order not to damage it.

Furthermore, to use a CO₂-based gas with a CO₂-type laser is not desirable since there is a risk of the CO₂ absorbing the energy of the laser beam.

Conversely, the presence of oxygen may be beneficial to the welding of certain materials such as steels. This is because, despite the presence of the laser welding plasma or of the metal vapors present in the interaction zone which will naturally be a site of fixing or confining the electric arc, it may prove necessary to further stabilize the electric arc, especially by injecting a little oxygen into the interaction zone so as to create on the surface of the puddle oxides onto which the electric arc will catch.

From these observations, it is one object of the invention therefore to provide an improved hybrid welding process allowing effective welding of workpieces made of various materials and using various gases or gas mixtures, used judiciously in order to avoid the abovementioned incompatibility problems and thus to be able to obtain quality welds.

The invention therefore relates to a hybrid process for welding one or more metal workpieces to be joined together by producing at least one welded joint between the edges to be welded of the said metal workpiece or workpieces, the said welded joint being obtained by using at least one laser beam and at least one electric arc, in which process, during welding of the joint, at least one part of the welding zone comprising at least one part of said welded joint is shielded during the operation with at least one shielding atmosphere formed by a gas mixture consisting of:

argon and/or helium with a content greater than or equal to 70% by volume; and

at least one additional compound chosen from H₂, O₂, CO₂ and N₂ with a content of 0 to 30% by volume.

Depending on the case, the welding process of the invention may comprise one or more of the following characteristics:

the content of at least one additional compound chosen from H₂, O ₂, CO₂ and N₂ is non zero and less than or equal to 20% by volume, preferably non zero and less than or equal to 15% by volume;

the shielding atmosphere is formed by a gas mixture consisting of argon with a content greater than or equal to 70% by volume and of at least one additional compound chosen from H₂, O₂, CO₂ and N₂ with a content of 0.1 to 30% by volume, preferably a gas mixture consisting of argon with a content greater than or equal to 70% by volume and of 0.1 to 30% by volume of an additional compound chosen from H₂, O₂, CO₂ and N₂;

the shielding atmosphere is formed by a gas mixture consisting of argon with a content greater than or equal to 70% by volume and of 0.1 to 30% by volume of several additional compounds chosen from H₂, O₂, CO₂ and N₂, preferably a mixture of argon, O₂ and CO₂;

the shielding atmosphere is formed by a gas mixture consisting of helium with a content greater than or equal to 70% by volume and of at least one additional compound chosen from H₂, O₂, CO₂ and N₂ with a content of 0.1 to 30% by volume, preferably a gas mixture consisting of helium with a content greater than or equal to 70% by volume and of 0.1 to 30% by volume of an additional compound chosen from H₂, O₂, CO₂ and N₂;

the shielding atmosphere is formed by a gas mixture consisting of helium with a content greater than or equal to 70% by volume and of 0.1 to 30% by volume of several additional compounds chosen from H₂, O₂, CO₂ and N₂, preferably a mixture of helium, O₂ and CO₂ and furthermore possibly containing H₂;

the shielding atmosphere is formed by a gas mixture consisting of at least 70% by volume of helium and argon and of 0.1 to 30% by volume of at least one additional compound chosen from H₂, O₂, CO₂ and N₂, preferably a gas mixture consisting of 0.1% to 69.9% by volume of helium, of 0.1% to 69.9% by volume of argon and of 0.1 to 30% by volume of at least one additional compound chosen from H₂, O₂, CO₂ and N₂, the sum of the argon and helium contents being at least 70% of the total volume of the mixture;

the workpiece or workpieces to be welded are made of a metal or a metal alloy chosen from coated or uncoated steels, particularly assembly steels, HLES steels, carbon steels, steels having a layer of zinc alloy on the surface, stainless steels, aluminum or aluminum alloys and high yield point steels;

the shielding atmosphere is formed by a gas mixture consisting of at least 70% by volume of helium and/or argon and of 0.1 to 30% by volume of at least one additional compound chosen from O₂ and CO₂ and the workpiece or workpieces to be welded are made of steel, especially carbon steel;

the shielding atmosphere is formed by a gas mixture consisting of at least 70% by volume of helium, of 0.1 to 30% by volume of hydrogen and of 0 to 29.9% by volume of at least one additional compound chosen from O₂ and CO₂, and the workpiece or workpieces to be welded are made of stainless steel;

the shielding atmosphere is formed by a gas mixture consisting of at least 90% by volume of helium or argon and of 0.1 to 10% by volume of at least one additional compound chosen from O₂ and CO₂, and the workpiece or workpieces to be welded are made of aluminum, preferably of at least 96% by volume of helium or argon and of 0.1 to 4% by volume of at least one additional compound chosen from O₂ and CO₂;

the shielding atmosphere is formed by a gas mixture consisting of at least 85% by volume of helium or argon and of 0.1 to 15% by volume of H₂, and the workpiece or workpieces to be welded are made of stainless steel, preferably of at least 90% by volume of helium or argon and of 0.1 to 10% by volume of H₂;

the shielding atmosphere is formed by a gas mixture consisting of at least 70% by volume of helium and/or argon and of 0.1 to 30% by volume of N₂, and the workpiece or workpieces to be welded are made of steel, preferably of at least 80% by volume of helium and/or argon and the balance being N₂;

the shielding atmosphere is formed by a gas mixture consisting of at least 85% by volume of helium and/or argon and of 0.1 to 15% by volume of H₂ and CO₂, and the workpiece or workpieces to be welded are made of stainless steel;

the laser beam is emitted by an Nd:YAG or CO₂ laser;

the electric arc is a plasma arc;

the electric arc is delivered by a plasma-arc torch and preferably the laser beam and said arc are delivered by a single welding head;

the electrode is consumable or not consumable.

The invention also relates to the use of the above welding process for welding at least one tailored blank intended to constitute at least one part of a vehicle body element.

The invention also relates to the use of the above welding process for joining together, by welding, metal workpieces having different thicknesses, particularly tailored blanks.

According to another aspect, the invention also relates to the use of the above welding process for joining together, by welding, metal workpieces having the same or different thicknesses and having different metallurgical compositions or metallurgical grades, particularly tailored blanks.

According to yet another aspect, the invention also relates to the use of the above welding process for joining together, by welding, the two longitudinal edges of a pre-tube.

On account of the possible geometries of welding heads, of the hybrid processes according to the invention and of the various means for feeding the gas or gas mixtures, the gas mixtures according to the invention which are mentioned below are those which are obtained in the interaction zone between the sheet or sheets to be welded and the laser and the arc, independently of the manner in which they may have been created.

Given in the examples below are several types of gas mixtures that can be used to weld various mixtures according to the present invention.

### EXAMPLES

Electric arc/laser hybrid welding with nonconsumable electrode

| | Contents | |
|---|---|---|
| Gas mixture | (% by volume) | Material welded |
| Ar + He + H₂ | H₂:<10 | Stainless steels |
| | Ar + He:the balance | |
| Ar + H₂ | H₂:<10 | Stainless steels |
| | Ar:the balance | |
| He + H₂ | H₂:<10 | Stainless steels |
| | He:the balance | |
| Ar + He + CO₂ | CO₂:<2 | Stainless steels |
| | Ar + He:the balance | |
| Ar + CO₂ | CO₂:<2 | Aluminum |
| | Ar:the balance | |
| Ar + O₂ | O₂:<2 | Aluminum |
| | Ar:the balance | |
| He + CO₂ | CO₂:<2 | Aluminum |
| | He:the balance | |
| Ar + N₂ | N₂:<20 | Steels (any type) |
| | Ar:the balance | |
| He + N₂ | N₂:<20 | Steels (any type) |
| | He:the balance | |
| Ar + He + N₂ | N₂:<20 | Steels (any type) |
| | He + Ar:the balance | |
| Ar + He + CO₂ | CO₂:<15 | Carbon steels |
| | Ar + He:the balance | |
| Ar + He + O₂ | O₂:<5 | Carbon steels |
| | Ar + He:the balance | |
| Ar + CO₂ | CO₂:<15 | Carbon steels |
| | Ar:the balance | |
| Ar + O₂ | O₂:<7 | Carbon steels |
| | Ar:the balance | |
| He + CO₂ | CO₂:<15 | Carbon steels |
| | He:the balance | |
| He + O₂ | O₂:<7 | Carbon steels |
| | He:the balance | |
| | O₂:<5 | |
| Ar + CO₂ + O₂ | CO₂:<10 | Carbon steels |
| | Ar:the balance | |
| | O₂:<5 | |
| He + CO₂ + O₂ | CO₂:<10 | Carbon steels |
| | He:the balance | |
| | H₂:<2 | |
| Ar + He + CO₂ + H₂ | CO₂:<2 | Stainless steels |
| | Ar:the balance | |
| Ar + CO₂ | CO₂:<2 | Aluminum |
| | Ar:the balance | Stainless steels |
| Ar + O₂ | O₂:<2 | Aluminum |
| | Ar:the balance | Stainless steels |
| He + CO₂ | CO₂:<2 | Aluminum |
| | He:the balance | Stainless steels |
| He + O₂ | O₂:<2 | Aluminum |
| | He:the balance | Stainless steels |

1. A process for welding one or more metal workpieces to be joined together by producing at least one welded joint between the edges to be welded of the said metal workpiece or workpieces, the said welded joint being obtained by using at least one laser beam and at least one electric arc, in which process, during welding of the joint, at least one part of the welding zone comprising at least one part of said welded joint is shielded during the operation with at least one shielding atmosphere formed by a gas mixture consisting of:
argon and/or helium with a content greater than or equal to 70% by volume; and
at least one additional compound chosen from H₂, O₂, CO₂ and N₂ with a content of 0 to 30% by volume.

2. The welding process as claimed in claim 1, wherein the content of at least one additional compound chosen from H₂, O₂, CO₂ and N₂ is non zero and less than or equal to 20% by volume, preferably non zero and less than or equal to 15% by volume.

3. The welding process as claimed in either of claims 1 and 2, wherein the shielding atmosphere is formed by a gas mixture consisting of argon with a content greater than or equal to 70% by volume and of at least one additional compound chosen from H₂, O₂, CO₂ and N₂ with a content of 0.1 to 30% by volume, preferably a gas mixture consisting of argon with a content greater than or equal to 70% by volume and of 0.1 to 30% by volume of an additional compound chosen from H₂, O₂, CO₂ and N₂.

4. The welding process as claimed in one of claims 1 to 3, wherein the shielding atmosphere is formed by a gas mixture consisting of argon with a content greater than or equal to 70% by volume and of 0.1 to 30% by volume of several additional compounds chosen from H₂, O₂, CO₂ and N₂, preferably a mixture of argon, O₂ and CO₂.

5. The welding process as claimed in either of claims 1 and 2, wherein the shielding atmosphere is formed by a gas mixture consisting of helium with a content greater than or equal to 70% by volume and of at least one additional compound chosen from H₂, O₂, CO₂ and N₂ with a content of 0.1 to 30% by volume, preferably a gas mixture consisting of helium with a content greater than or equal to 70% by volume and of 0.1 to 30% by volume of an additional compound chosen from H₂, O₂, CO₂ and N₂.

6. The welding process as claimed in one of claims 1, 2 or 5, wherein the shielding atmosphere is formed by a gas mixture consisting of helium with a content greater than or equal to 70% by volume and of 0.1 to 30% by volume of several additional compounds chosen from H₂, O₂, CO₂ and N₂, preferably a mixture of helium, O₂ and CO₂ and furthermore possibly containing H₂.

7. The welding process as claimed in one of claims 1 to 6, wherein the shielding atmosphere is formed by a gas mixture consisting of at least 70% by volume of helium and argon and of 0.1 to 30% by volume of at least one additional compound chosen from H₂, O₂, CO₂ and N₂, preferably a gas mixture consisting of 0.1% to 69.9% by volume of helium, of 0.1% to 69.9% by volume of argon and of 0.1 to 30% by volume of at least one additional compound chosen from H₂, O₂, CO₂ and N₂, the sum of the argon and helium contents being at least 70% of the total volume of the mixture.

8. The welding process as claimed in one of claims 1 to 7, wherein the workpiece or workpieces to be welded are made of a metal or a metal alloy chosen from coated or uncoated steels, particularly assembly steels, HLES steels, carbon steels, steels having a layer of zinc alloy on the surface, stainless steels, aluminum or aluminum alloys and high yield point steels.

9. The welding process as claimed in one of claims 1 to 8, wherein the shielding atmosphere is formed by a gas mixture consisting of at least 70% by volume of helium and/or argon and of 0.1 to 30% by volume of at least one additional compound chosen from O₂ and CO₂ and wherein the workpiece or workpieces to be welded are made of steel, especially carbon steel.

10. The welding process as claimed in one of claims 1 to 8, wherein the shielding atmosphere is formed by a gas mixture consisting of at least 70% by volume of helium, of 0.1 to 30% by volume of hydrogen and of 0 to 29.9% by volume of at least one additional compound chosen from O₂ and CO₂, and wherein the workpiece or workpieces to be welded are made of stainless steel.

11. The welding process as claimed in one of claims 1 to 8, wherein the shielding atmosphere is formed by a gas mixture consisting of at least 90% by volume of helium or of argon and of 0.1 to 10% by volume of at least one additional compound chosen from O₂ and CO₂, and wherein the workpiece or workpieces to be welded are made of aluminum, preferably of at least 96% by volume of helium or argon and of 0.1 to 4% by volume of at least one additional compound chosen from O₂ and CO₂.

12. The welding process as claimed in one of claims 1 to 8, wherein the shielding atmosphere is formed by a gas mixture consisting of at least 85% by volume of helium or of argon and of 0.1 to 15% by volume of H₂, and wherein the workpiece or workpieces to be welded are made of stainless steel, preferably of at least 90% by volume of helium or argon and of 0.1 to 10% by volume of H₂.

13. The welding process as claimed in one of claims 1 to 8, wherein the shielding atmosphere is formed by a gas mixture consisting of at least 70% by volume of helium and/or argon and of 0.1 to 30% by volume of N₂, and wherein the workpiece or workpieces to be welded are made of steel, preferably of at least 80% by volume of helium and/or argon and the balance being N₂.

14. The welding process as claimed in one of claims 1 to 8, wherein the shielding atmosphere is formed by a gas mixture consisting of at least 85% by volume of helium and/or argon and of 0.1 to 15% by volume of H₂ and CO₂, and wherein the workpiece or workpieces to be welded are made of stainless steel.

15. The welding process as claimed in one of claims 1 to 14, wherein the laser beam is emitted by an Nd:YAG or CO₂ laser and/or wherein the electric arc is a plasma arc.

16. The welding process as claimed in one of claims 1 to 15, wherein the electric arc is delivered by a plasma-arc torch and preferably the laser beam and said arc are delivered by a single welding head.

17. The welding process as claimed in one of claims 1 to 16, wherein the electrode is consumable or not consumable.

18. Use of a welding process as claimed in one of claims 1 to 17 for welding at least one tailored blank intended to constitute at least one part of a vehicle body element.

19. Use of a welding process as claimed in one of claims 1 to 17 for joining together, by welding, metal workpieces having different thicknesses, particularly tailored blanks.

20. Use of a welding process as claimed in one of claims 1 to 17 for joining together, by welding, metal workpieces having the same or different thicknesses and having different metallurgical compositions or metallurgical grades, particularly tailored blanks.

21. Use of a welding process as claimed in one of claims 1 to 17 for joining together, by welding, the two longitudinal edges of a pre-tube.
